(19) United States
(12) Patent Application Publication
(10) Pub. No.: US 2023/0069224 A1
(43) Pub. Date: Mar. 2, 2023

(54) VESSEL STORAGE SUPPORT SYSTEM

(71) Applicant: Gregory Stumpf, Andover, MN (US)

(72) Inventor: Gregory Stumpf, Andover, MN (US)

(21) Appl. No.: 17/411,959

(22) Filed: Aug. 25, 2021

(51) Int. Cl. B60D 1/66; B60D 1/06; F16M 11/20; F16M 11/28

(52) U.S. Cl. CPC B60D 1/66; B60D 1/06; F16M 11/2021; F16M 11/28; F16M 2200/028; F16M 2200/08

(57) ABSTRACT

Described herein are systems and methods for storing moveable vessels, such as RVs, trailers, and boats, in a level position on any type of storage surface (e.g., sloped driveway, uneven ground). Such vessels may continue to operate properly and/or may not become damaged. A vessel support system for supporting a moveable vessel can include a base and a leg that is coupled to and extending from the base. The leg can pivot relative to the base and can be fixedly supported at the base in at least one position. The leg can engage a hitch coupler of the moveable vessel, and the leg can, based on the base being positioned at a sloped surface, extend vertically to thereby support the moveable vessel at the hitch coupler of the moveable vessel. An extendable portion can also attach to the leg and extend to different lengths to support vessels of different heights.

### TECHNICAL FIELD

This document describes devices, systems, and methods related to storage support systems for moveable vessels, such as campers and boats.

### BACKGROUND

Moveable vessels such as campers and boats can be stored on driveways, in garages, in boat yards, and in other storage locations. The moveable vessels can be stored for short periods of time, such as over a week and/or between weekend trips. The moveable vessels can also be stored for longer periods of time, such as over a winter season. Storage locations may not have a level ground surface. For example, some driveways can be sloped. Other ground surfaces may be uneven and/or have varying degrees of incline or decline. As a result, keeping a moveable vessel level when storing it in such a storage location can be challenging. A user may, for example, stack blocks (e.g., wooden blocks) beneath a hitch coupler or jack leg of the moveable vessel. Blocks can move beneath the weight of the moveable vessel, especially when more weight is added to the moveable vessel. The blocks may also shift, become damaged, or otherwise break, thereby causing one or more of the blocks to dislodge and for the moveable vessel to collapse. It can be challenging for the human eye to gauge how many blocks and what size blocks to use in order to keep the moveable vessel in a level position relative to the slope of the ground surface. A user may also attach a support stand to a jack leg of the moveable vessel. However, the support stand may not adjust to the slope of the ground surface, nor may the support stand adjust in height to accommodate for different size moveable vessels.

### SUMMARY

The document relates to a storage support system for moveable vessels, such as campers, RVs, boats, and/or trailers. In particular, this disclosure provides a support system that can be used to store a variety of types of moveable vessels in different types of storage locations. Some storage locations can include driveways, garages, boat yards, fields, open lots, and/or other locations. A storage location may not have an even ground surface. For example, a driveway can be sloped up and/or down. The storage location can also have a ground surface that is not level or otherwise has varying degrees of incline and/or decline. It can be preferred to store moveable vessels to be level (or positioned horizontally) regardless of the slope or unevenness of the storage ground, so that components of the moveable vessel continue to operate appropriately. Maintaining the moveable vessel to be level (or positioned horizontally) can also be preferred to avoid damage to the moveable vessel and/or components therein while in storage.

The support system described herein can include a base and a leg coupled to the base. The leg can extend away from the base and can pivot relative to the base to support the moveable vessel level, regardless of how angled a support surface that the base is placed on. Therefore, the leg can be fixedly supported at the base in at least one position to accommodate for how uneven the support surface may be. The leg can engage a hitch coupler of the moveable vessel in order to securely attach the support system to the moveable vessel and support the moveable vessel on the sloped surface. As described herein, the leg can extend from the base at different lengths in order to accommodate for different heights of moveable vessels. As a result, the support system can be adapted and utilized to store different types of movable vessels.

In some implementations, the support system can include a support leg that attaches to a pivotable base (e.g., swivel base). The pivotable base can automatically adjust to a slope of the support surface, such as a driveway. For example, the pivotable base can pivot forwards and backwards so that it is flush against the slope of the driveway. The support leg can lock into place in the pivotable base by an alignment pin (e.g., hitch pin) that secures through J-Hook stops (e.g., J shaped apertures) of the pivotable base and corresponding apertures on the support leg. As a result, a user can set up the support system on any surface without the use of additional tools. The support leg can extend in a vertical direction regardless of how much the pivotable base is pivoted forwards or backwards. The support system can also include an extendable portion that extends up from the support leg so that the support system can be used with moveable vessels of varying sizes and heights. The extendable portion can be locked at a desired height by inserting an alignment pin (e.g., hitch pin) through corresponding alignment apertures on both the support leg and the extendable portion. Moreover, a user can attach a desired hitch adapter (e.g., ball shape) to the support system, which can receive a corresponding hitch coupler of the moveable vessel. The hitch adapter and hitch coupler can be locked together to prevent theft of the moveable vessel and to ensure that the moveable vessel is securely supported by the support system regardless of the slope or unevenness of the support surface.

Some moveable vessels can be temporarily stored for short periods of time. For example, an RV or camper can be temporarily stored on a user's driveway during the week, and taken out on the weekends to go on trips/camping. While temporarily storing the RV or camper on the driveway, the user may wish to continue running one or more components of the RV or camper, such as a refrigerator. It can be preferred to keep the refrigerator operating so that the user may not have to empty all the contents of the refrigerator for the short amount of time that the RV or camper is stored in the driveway before the next weekend trip/camping. The user may also want to continue using components of the RV or camper, such as a slide out. If the RV or camper is resting on an uneven surface, however, the user may not be able to run the refrigerator or use or other components. If the user tries to operate components of the RV or camper, it may cause damage. The disclosed technology, therefore, provides a support system that can be used for temporary storage of moveable vessels like the RV or camper. The support system can maintain the RV or camper in a level position regardless of a slope or unevenness of surface where the RV or camper is being stored. As a result, the user can continue to operate components of the RV or camper without causing damage.

Some moveable vessels can be stored for longer periods of time. For example, a boat can be stored on a driveway or in a boat yard during off-season months, such as winter. By propping the boat on the support surface at a slight angle, any rainwater that collects inside can drain out through an open back drain. As a result, the user may not have to pump the rainwater out of the boat.

One or more embodiments described herein can include a vessel support system for supporting a moveable vessel, the system including a base and a leg that is coupled to and extending from the base. The leg can pivot relative to the base and be fixedly supported at the base in at least one position. The leg can engage a hitch coupler of the moveable vessel, and the leg can, based on the base being positioned at a sloped surface, extend vertically to thereby support the moveable vessel at the hitch coupler of the moveable vessel.

In some implementations, the embodiments described herein can optionally include one or more of the following features. For example, the leg can extend from the base at different lengths to accommodate different heights of the moveable vessel. The different lengths can include a range between 24 inches and 42 inches.

As another example, the leg can include a support leg that is coupled to the base and an extendible portion that can extend from the support leg at different lengths that maintains the moveable vessel in a level position relative to the sloped surface. In some implementations, the extendible portion can telescope into and out of the support leg.

In some implementations, the leg can engage a hitch adapter, the hitch adapter being attached to the hitch coupler of the moveable vessel. In yet some implementations, the extendable portion can include a first opening at a top surface of the extendable portion configured to receive a base of a hitch adapter. The hitch adapter can include one or more surfaces that can support and releasably attach to the hitch coupler of the moveable vessel. In some implementations, the extendable portion can also include a second opening along a first side of the extendable portion proximate the top surface. The second opening can receive a nut that can secure the base of the hitch adapter within a cavity of the extendable portion.

As another example, the base can include two J-Hook stops on opposing sides of the base, the leg can include two corresponding apertures that align with the two J-Hook stops of the base, and the two J-Hook stops of the base and the two corresponding apertures of the leg can receive at least one alignment pin that can couple the leg to the base in a position that maintains the moveable vessel level relative to the sloped surface.

One or more embodiments described herein can include a vessel support system for storage of a moveable vessel, the vessel support system including a base that supports a moveable vessel on a surface, a support leg that can include a first end and a second end, and an extendable portion that telescopes into and out of the support leg. The base can pivot forward and backward relative to a support leg to maintain the moveable vessel in a level position relative to the support leg. The first end of the support leg can attach to the base and the second end of the support leg can extend away from the base in a vertical direction. The extendible portion can extend a length along a substantially vertical dimension from the support leg. The extendable portion can include a first opening at a top surface of the extendable portion that can receive a base of a hitch adapter, and a second opening along a first side of the extendable portion proximate the top surface. The hitch adapter can include one or more surfaces that can support and releasably attach to a hitch coupler of the moveable vessel. The second opening can receive a nut that secures the base of the hitch adapter within a cavity of the extendable portion.

The embodiments described herein can include one or more of the following features. For example, the moveable vessel can be at least one of an RV, camper, boat, and trailer. As another example, the extendable portion can define alignment apertures that can receive at least one alignment pin when the extendable portion is extended to a desired length, at least one alignment pin can pass through alignment apertures in the support leg and the extendable portion to maintain the extendable portion at the desired length, and the at least one alignment pin can be a hitch pin.

In some implementations, the base can include two J-Hook stops on opposing sides of the base, the support leg can include two corresponding apertures that can align with the two J-Hook stops of the base, and the two J-Hook stops of the base and the two corresponding apertures of the support leg can receive at least one alignment pin that can couple the support leg to the base.

As another example, the support leg can be at least one of aluminum and steel. In some implementations, the support leg can have a first length of 24 inches when the extendable portion is entirely telescoped into the support leg and the support leg can have a second length of 42 inches when the extendable portion is telescoped out of the support leg and extended to a full desired length. Moreover, all a weight of the moveable vessel can be supported by the vessel support system.

One or more embodiments described herein can include a method for supporting a moveable vessel, the method including engaging a leg to a base, placing the base at a sloped surface, pivoting the leg relative to the base so that the leg can extend vertically from the base, fastening the leg to the base with the leg extending vertically from the base to maintain the moveable vessel level relative to the sloped surface, and engaging a hitch coupler of the moveable vessel to the leg.

The method described herein can include one or more of the abovementioned features and/or one or more of the following features. For example, the method can also include inserting an extendable portion into the leg such that the extendable portion telescopes into and out of the leg, extending the extendable portion out of the leg to a desired length, and engaging the extendable portion to the leg at the desired length by inserting an alignment pin through corresponding apertures of the extendable portion and the leg.

As another example, engaging a hitch coupler of the moveable vessel to the leg can include inserting a base of a hitch adapter through an opening at a top surface of the extendable portion, inserting a nut through a second opening along a side of the extendable portion and adjacent to the top surface, fastening the nut around the base of the hitch adapter to releasably couple the base of the hitch adapter inside a cavity of the extendable portion, and lowering the hitch coupler of the moveable vessel onto the hitch adapter.

As yet another example, engaging a hitch coupler of the moveable vessel to the leg can include inserting a base of a hitch adapter through an opening at a top surface of the extendable portion, threading the base of the hitch adapter into a cavity of the extendable portion to releasably couple the hitch adapter to the extendable portion, and lowering the hitch coupler of the moveable vessel onto the hitch adapter.

The devices, system, and techniques described herein may provide one or more of the following advantages. For example, the disclosed technology provides for components of the moveable vessel to continue operating properly while the vessel is in storage. The user may prefer to continuously operate components of the RV (or other moveable vessel described herein) because then the user may not have to remove items from the refrigerator for the short amount of time that the RV is being stored. Components such as the refrigerator, air conditioner, and slide out may only operate when an RV is level relative to the ground, otherwise they can be damaged. For example, operating the refrigerator on an uneven surface runs the risk of damaging the refrigerator's cooling unit since these refrigerators use gravity to create heat that makes an inside of the refrigerator cool. Similar damage can be caused to the air conditioner when the RV is not level. Operating the slide out on an uneven surface can cause gears of the slide out to bind up and become damaged. Some users may stack blocks underneath the RV's hitch coupler or jack leg in an attempt to keep the RV level. However, it can be challenging to gauge whether the user is using enough blocks to maintain the RV level. The user may think that the RV is level when in reality it is not. The user may then try operating the refrigerator and/or slide out, thereby causing costly damage to such components. The disclosed technology, on the other hand, provides for easily maintaining the RV in a level position so that components can continue to operate damage-free. The disclosed technology can be easy to attach to the RV and adjust to a desired height to support a size and height of the RV. The disclosed technology can also automatically adjust to a slope or other unevenness of the storage surface without intervention or action from the user. Accordingly, the disclosed technology can reduce or otherwise eliminate human error that may arise from having to gauge how many blocks should be placed under the RV hitch coupler or jack leg to keep the RV at a level position while being stored.

As another example, the disclosed technology provides for removing weight of the moveable vessel from a jack leg and focusing the weight on the disclosed support system. As mentioned above, some users may stack blocks underneath the jack leg to support the moveable vessel during storage. Some users may also use a support stand that attaches to the jack leg to support the vessel. Either approach can cause the weight of the moveable vessel to be focused at the jack leg, thereby causing damage to the jack leg. Either approach may also cause damage to the stacked blocks, which can cause the moveable vessel to collapse. As an example, the jack leg can fail and break. This can be especially true if the moveable vessel is being stored for extended periods of time. The disclosed technology, on the other hand, provides for distributing the weight of the moveable vessel to the support system, which attaches to the hitch coupler of the moveable vessel. Removing the weight from the jack leg can preserve the jack leg and prevent the jack leg and/or the stacked blocks from breaking or otherwise becoming damaged.

As yet another example, the disclosed technology provides for theft prevention. Using the disclosed technology, a user can simply pull a fuse of an electric jack to prevent the electric jack from operating. As a result, the user may not have to use a tongue lock to secure the moveable vessel, which can be easily cut by others to steal the moveable vessel. Moreover, because the fuse is pulled, the electric jack cannot be actuated to raise and/or lower the moveable vessel. The moveable vessel may not be moved, which therefore prevents others from stealing the moveable vessel.

Moreover, the disclosed technology can adjust in height and automatically swivel to support the moveable vessel in a level position on any type of surface. Sometimes, a user may not have enough blocks to place beneath the vessel's jack leg so that the vessel appears to be level with the support surface. Sometimes, the support surface may be so sloped that, regardless of how many blocks the user has, the vessel will not be level with the support surface. Moreover, sometimes, the user can use a support stand that attaches to the jack leg. However, the support stand may be fixed in height and may not have a flexible, adjustable base. Therefore, the support stand may not provide for the vessel to be maintained in a level position relative to the slope of the support surface. The disclosed technology, therefore, provides for ease in extending a height of the support system, which accommodates different sized vessels and different types of conditions that the support surface may have. For example, if a driveway is steeply sloped, the extendable portion of the support system can be extended more than if the driveway is relatively flat in order to maintain the RV in a level position. The disclosed technology also provides for automatic adjustment to different conditions of the support surface. For example, the pivotable base pivots to match a slope of the driveway while maintaining the support leg locked in a vertical direction.

The disclosed technology also provides stability and support to the vessel when it is stored. Blocks can move beneath the weight of the vessel, especially when more weight is added to the vessel and/or users are inside the vessel and moving around. Sometimes, the blocks can shift, become damaged, or otherwise break, thereby causing one or more of the blocks to dislodge and for the vessel to collapse. A support stand that attaches to a jack leg may also not be strong enough or stable enough to withstand added weight. Thus, the jack leg and/or the support stand can break or otherwise fail, causing damage to the vessel and collapse of the vessel. Such configurations can be unsafe. Such configurations may also cause costly damage to the vessel. The disclosed technology, on the other hand, provides for the weight of the vessel, and any added weight, to be distributed to the support system, which attaches to the hitch coupler of the vessel. This provides for stability and distributed support, even when more weight is added to the vessel, such as users moving around inside the vessel. The more stable support of the disclosed technology can also prevent damage or failures to components of the vessel, such as the jack leg, and can also be safer to use.

The disclosed technology provides for a toolless system, which makes it easier and intuitive for any user to attach and detach the support system to the moveable vessel. No tools are required to attach or adjust the support system relative to the moveable vessel. The pivotable base automatically adjusts to a slope of the support surface. The user may lock the support leg in place in the pivotable base using a hitch pin that threads through or is put/placed through J-Hook stops on the pivotable base and corresponding apertures on the support leg. Once the hitch pin locks into place, the support leg can be secured to the pivotable base and may not move under the weight of the vessel. The user may also extend the extendable portion from the support leg to adjust a height of the support system. The extendable portion can then be secured at the desired height using another hitch pin. The user can also lower the hitch coupler of the vessel onto a hitch adapter of the user's desired size without having to use additional tools or fastening mechanisms. Therefore, the user can easily and intuitively attach or detach the support system to the moveable vessel.

As another example, the disclosed support system can be made of lightweight materials, thereby making it easier for use. Since the support system can be lightweight, the user can easily attach and detach the support system without tools or assistance from another user. The user can also bring the support system with them. Because the support system is light and collapsible (e.g., all the components detach from each other as described above), the user can store the support system in the moveable vessel and/or a vehicle that tows the moveable vessel. The user can then use the support system in different locations, whether for storage, camping, or other activities.

As yet another example, the disclosed technology can be adjustable and adaptable for use with different types of moveable vessels, regardless of their dimensions, size, height, and/or weight. The support system can be used for storage of RVs, campers, trailers, and boats. For example, a user can desire to use the support system for temporary storage of an RV during camping season and long term storage of a boat during winter season. To use the same support system to support different types of vessels, the user may merely adjust a height of the extendable portion of the support system to accommodate for different size of the vessels and/or location of storage for each of the vessels.

Moreover, the disclosed technology can be used to store a boat for long periods of time without collecting rainwater. Since the support system described herein can adjust to varying degrees of slope, the support system can be angled slightly such that a back drain can be left open in the boat and rainwater can automatically drain out of the boat. Otherwise, drain water can collect, cause damage to components of the boat, and/or require the user to pump the rainwater out of the boat when taking the boat out of storage. The disclosed technology, therefore, can reduce or otherwise avoid potential damage to the boat and costs of fixing the damage when stored for long periods of time.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is an example view of a moveable vessel support system described herein.

FIG. 2 depicts example adjustment of the moveable vessel support system.

FIG. 3 depicts components of the moveable vessel support system when disassembled.

FIG. 4 is an example view of a pivotable base of the moveable vessel support system.

FIG. 5 depicts the moveable vessel support system in operation with an example moveable vessel.

FIG. 6 is a flowchart of a process for assembling the moveable vessel support system described herein.

Like reference symbols in the various drawings indicate like elements.

### DETAILED DESCRIPTION OF ILLUSTRATIVE EMBODIMENTS

This document relates to storage support system for moveable vessels, such as campers, RVs, boats, and/or trailers. In particular, this disclosure provides a support system that can be used to store a variety of types of moveable vessels in different types of storage locations to level the moveable vessel on an even surface in a storage location. Example moveable vessels include but are not limited to travel trailers (e.g., 0 lb, 8,000 lb-20,000 lb, and/or 12,000-15,000 lb trailers), campers, boats, cargo trailers, landscape trailers, car haulers, motorcycle trailers, and/or snowmobile trailers. The storage locations can include but are not limited to driveways, garages, boat yards, open lots, surface lots, grass, fields, campgrounds, or other types of locations where a moveable vessel can be parked. The storage locations may also have different characteristics, such as an uneven surface (e.g., uneven or sloping storage ground), a slope (e.g., incline or decline), etc. The disclosed technology therefore provides for storing moveable vessels in a level position (e.g., horizontally) on any type of storage surface. As a result, such vessels may continue to operate properly and/or may not become damaged. The disclosed technology can also provide for: safer storage of moveable vessels than on wood blocks or any other types of blocks that may be used (e.g., such blocks can split from pressure of a jack leg and weight of the moveable vessel applied thereon), vertical adjustability to a desired height, adjustment and support on any angled/sloped/uneven surface of a storage location, extending the life of the jack leg since the weight of the moveable vessel is supported by the support system rather than the actual jack leg of the moveable vessel, easy storage since components of the support system can be detached from each other and/or folded down into one piece for flatter storage, and stability for loading and unloading the moveable vessel.

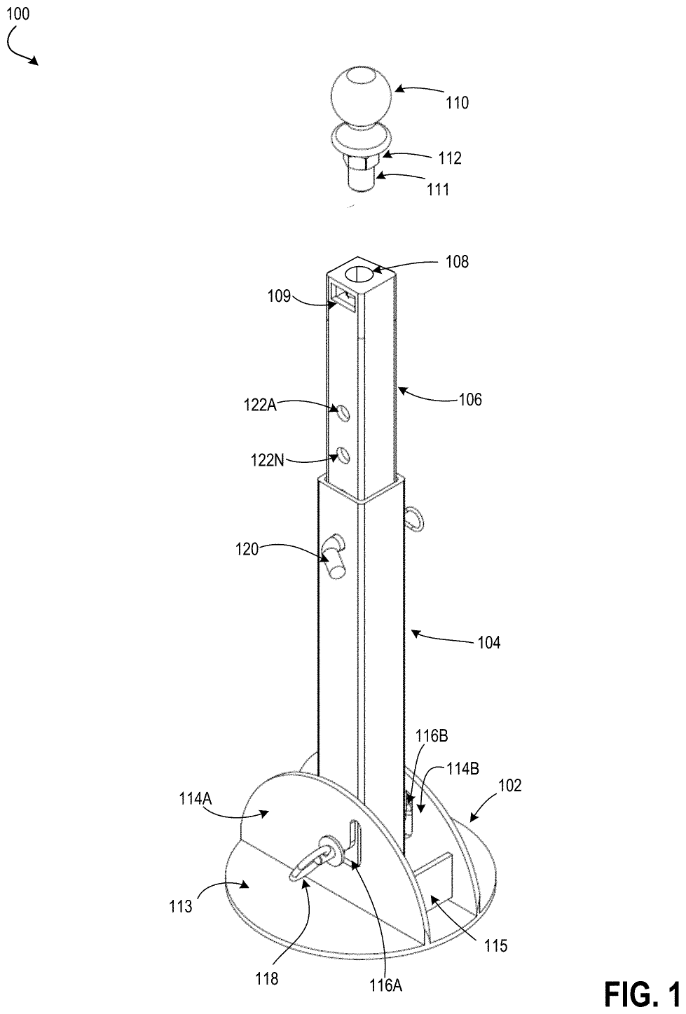

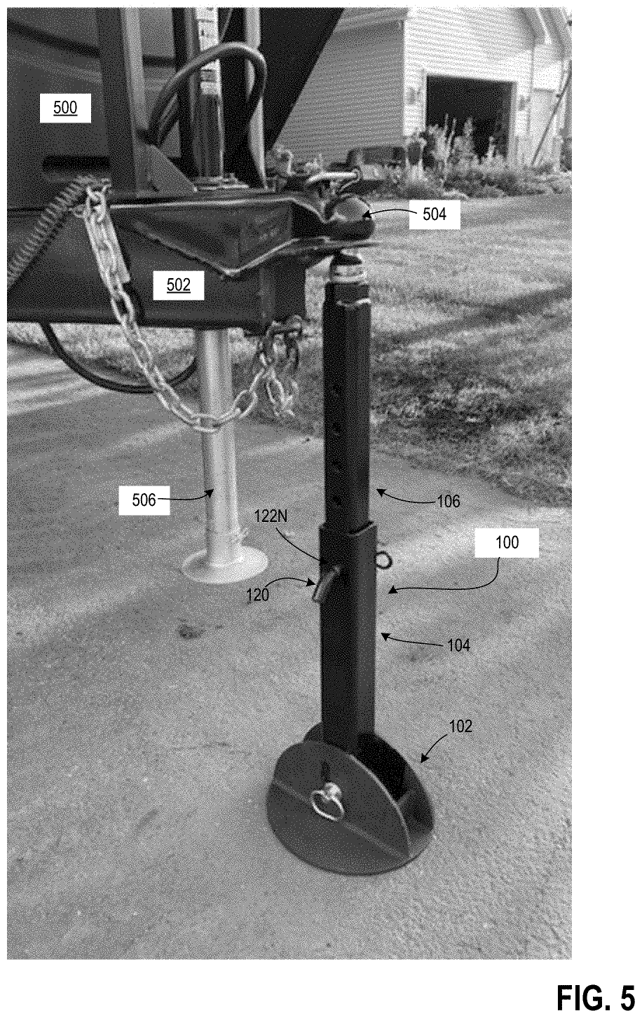

Referring to the figures, FIG. 1 is an example view of a moveable vessel support system 100 described herein. The moveable vessel support system 100 (e.g., the system 100), includes a pivotable base 102, a support leg 104 (e.g., leg stand), and an extendable portion 106 (e.g., adjustable leg). A hitch adapter 110 can also be attached to the system 100 to receive a hitch coupler of a moveable vessel (e.g., refer to FIG. 5).

The pivotable base 102 can include a base plate 113. The base plate 113 can be a 10″ circular plate. Thus, the base plate 113 may not dig into soft surfaces, such as grass, asphalt, and/or gravel. This size of the base plate 113 can also be preferred to provide support and stability to maintain the moveable vessel in a level position relative to a slope or angle of the ground surface. One or more other base plate 113 sizes can also be used, for example, depending on a size and/or weight of the moveable vessel that is being supported by the system 100.

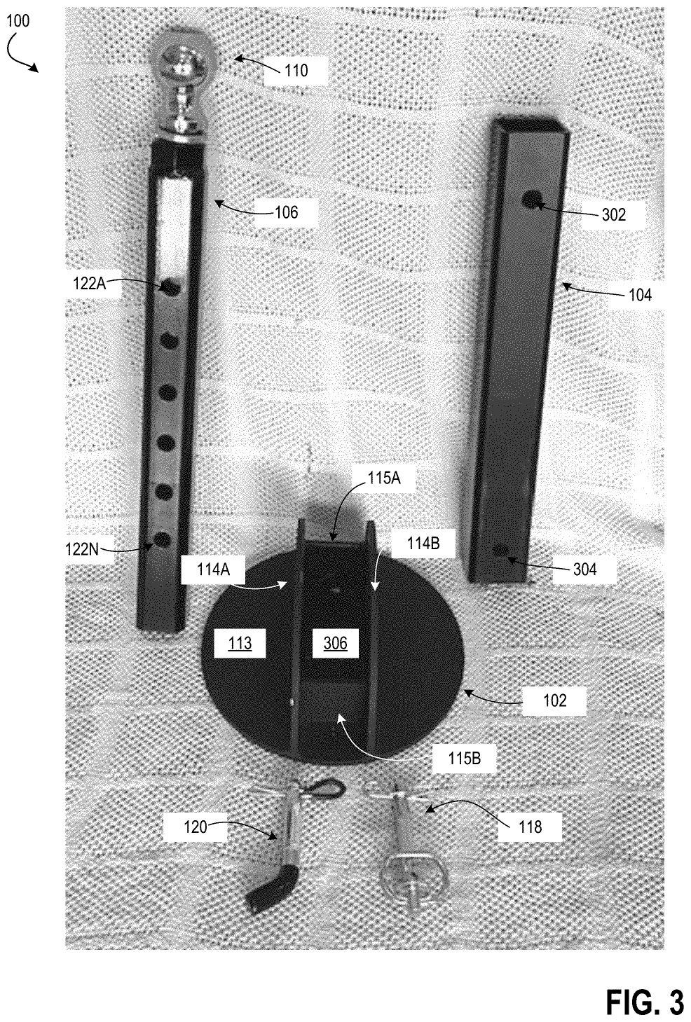

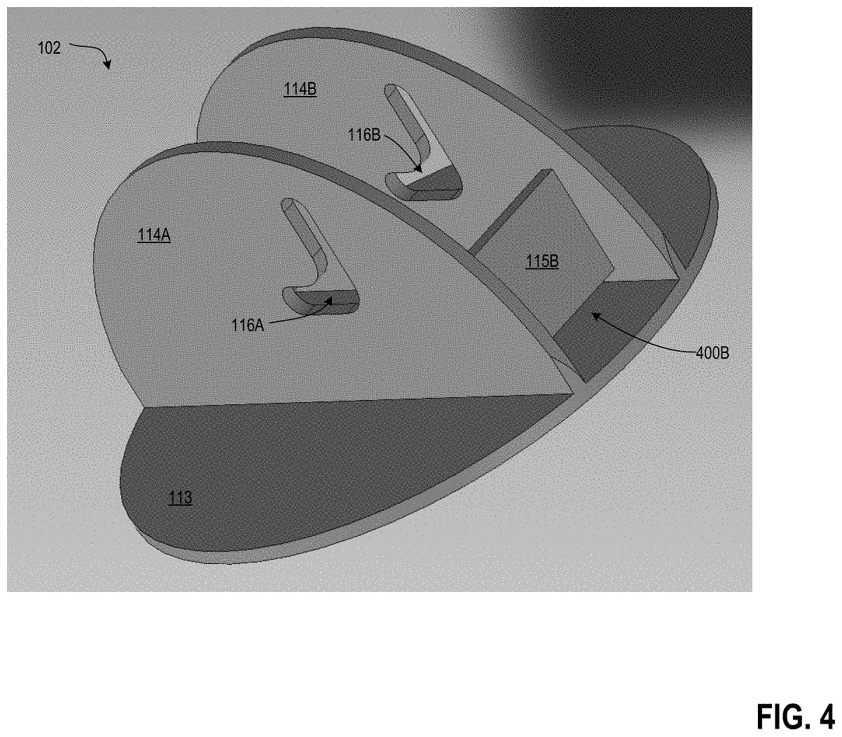

Side walls 114A and 114B can extend perpendicularly up from the base plate 113 and parallel to each other. Each of the side walls 114A and 114B can have respective J-Hook stops 116A and 116B. The J-Hook stops 116A and 116B can align with apertures in the support leg 104 (e.g., refer to FIG. 3) when the support leg 104 is positioned between the side walls 114A and 114B, as shown in FIG. 1. The pivotable base 102 can also include gussets 115 that extend between the side walls 114A and 114B (e.g., refer to FIG. 3). The gussets 115, or similar type brackets, can provide support to strengthen the system 100. An opening can be formed between each gusset 115 and the base plate 113 such that any water collection in a space formed by the side walls 114A and 114B and the gussets 115 can automatically drain out (e.g., refer to FIG. 4).

Moreover, a hitch pin 118, or similar alignment pin, can be threaded through (e.g., put/placed through, inserted into) the J-Hook stops 116A and 116B of the side walls 114A and 114B and through the corresponding apertures of the support leg 104 in order to secure the support leg 104 to the pivotable base 102. Optionally, a spring cotter pin can be used to secure the hitch pin 118 in place. In some implementations, the hitch pin 118 can be a ⅝″×5″ hitch pin. One or more other desired hitch pin sizes can be used to secure the support leg 104 to the pivotable base 102.

As mentioned above, the support leg 104 can releasably attach to the pivotable base 102 using the hitch pin 118. The support leg 104 may also releasably attach to the extendable portion 106 using another hitch pin 120, or similar alignment pin. The hitch pin 120 can be, for example, a ½″×3″ hitch pin. The support leg 104 can have a cavity configured to receive the extendable portion 106. The extendable portion 106 can include one or more alignment apertures 122A-N. In operation, the user can pull the extendable portion 106 out of the support leg 104 to a desired height and can align one of the alignment apertures 122A-N with a corresponding aperture/opening in the support leg 104. The user can then thread (e.g., put, place, insert) the hitch pin 120 through the aperture of the support leg 104 and through the one of the alignment apertures 122A-N of the extendable portion. Optionally, the user can secure a spring cotter pin around the hitch pin 120 to ensure that the hitch pin 120 does not come out. Thus, the extendable portion 106 can extend in a substantially vertical direction from the support leg 104 so that the system 100 can be used with hitch couplers of moveable vessels that are varying heights from the ground.

The extendable portion 106 can also include an opening 108 in a top surface of the extendable portion 106. The opening 108 can receive a base 111 of the hitch adapter 110 within a cavity of the extendable portion 106. The opening 108 can be sized to receive bases 111 of hitch adapters 110 of varying sizes. Therefore, the user can select an appropriate size hitch adapter to use with their moveable vessel. The user can use the same system 100 with different types of moveable vessels by merely attaching a different hitch adapter to the system 100. Hitch adapters can be different sizes with different sized shanks, depending on the type of moveable vessel. As an illustrative example, boats may have 2″ hitch adapters while RVs may have 2 5/16″ hitch adapters. Therefore, the opening 108 can be sized such that it can receive the base 111 of the user-selected hitch adapter 110.

The extendable portion 106 also includes an opening 109 along a side of the extendable portion 106 and adjacent to the opening 108. For example, the opening 109 can be positioned near/along a top edge of the extendable portion 106 such that the opening 109 aligns with a nut 112 of the hitch adapter 110. The opening 109 can be sized such that the user can insert the nut 112 into the cavity of the extendable portion 106 to secure the base 111 of the hitch adapter 110 to the extendable portion 106. The hitch adapter 110 can therefore be attached to the system 100. In some implementations, the hitch adapter 110 can be threaded into the opening 108 of the extendable portion 106 without the nut 112. This can provide a simple and intuitive toolless connection between the hitch adapter 110 and the extendable portion 106, thereby allowing the user to quickly and easily swap out the hitch adapter 110.

In some implementations, the pivotable base 102, the support leg 104, and/or the extendable portion 106 can be manufactured in varying sizes to accommodate different types of moveable vessels. For example, the pivotable base 102 can have a larger diameter in order to support a larger RV in comparison to a supporting a motorcycle trailer. As another example, the support leg 104 and/or the extendable portion 106 can be of varying lengths to support different sizes, configurations, and weighs of moveable vessels. As an illustrative example, the support leg 104 can have a length in a range of values from 24″ to 42″. In yet some implementations, the extendable portion 106 can have a length in the range of values from 24″ to 42″. In some implementations, the system 100 may include the pivotable base 102 and the support leg 104 but not the extendable portion 106. The user can then attach the hitch adapter 110 directly to the support leg 104. The user can optionally add the extendable portion 106 to the system 100 in order to use the system 100 with other moveable vessels.

In some implementations, the pivotable base 102 can be a rubber-coated material, such as steel and/or aluminum. The support leg 104 can be a powder-coated material, such as steel and/or aluminum. The extendable portion 106 may also be a powder-coated material in some implementations, such as steel and/or aluminum. One or more other materials can be used to manufacture the components of the system 100 such that the system 100 can be structurally supportive of weights of different types of moveable vessels while also being lightweight for ease of assembly, disassembly, and storage.

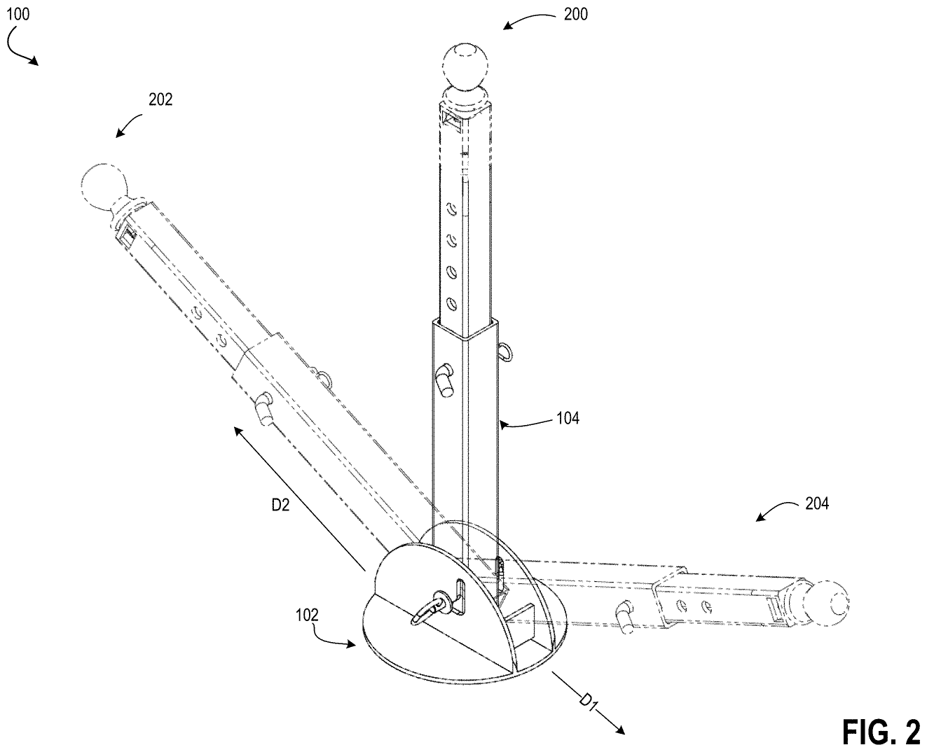

FIG. 2 depicts example adjustment of the moveable vessel support system 100. As described herein, the system 100 can be used to maintain the moveable vessel in a level position on an uneven surface. The system 100 can be used, for example, to store the moveable vessel on a sloping driveway. The pivotable base 102 can rest flat against the uneven surface (e.g., the slope of the driveway) by pivoting forward and backward to conform to the uneven surface. The support leg 104 can extend from the pivotable base 102 at an angle perpendicular to the uneven surface such that the moveable vessel supported by the system 100 is maintained in a level position.

Thus, as shown in position 200, the support leg 104 can extend perpendicular from the base 102 when placed on a flat surface. In position 202, the base 102 can be placed on a surface that is sloping in direction D1. To support the moveable vessel in a level position, the support leg 104 can extend in a direction D2, opposite the direction D1. In position 204, the base 102 can be placed on a surface that slopes in direction D2. To support the moveable vessel in a level position, the support leg 104 can extend in a direction D1, opposite the direction D2.

FIG. 3 depicts components of the moveable vessel support system 100 when disassembled. As shown, the extendable portion 106 and the support leg 104 can be decoupled from the base 102. The user can optionally remove the hitch adapter 110 as well. In some implementations, the user can leave the hitch adapter 110 attached to the extendable portion 106 and/or remove the hitch adapter 110 such that a hitch adapter of a different size can be attached to the extendable portion 106.

In the example of FIG. 3, the extendable portion 106 has 6 alignment apertures 122A-N that each extend through the extendable portion 106 from one side to an opposing side. The alignment apertures 122A-N here provide 6 different height adjustments of the extendable portion 106. The extendable portion 106 can have fewer or additional alignment apertures 122A-N, which can be based, at least in part, on size, type, weight, height, and/or configuration of a moveable vessel that is used with the system 100.

The support leg 104 has an aperture 302 that extends through the support leg 104 from one side to an opposing side of the support leg 104. The aperture 302 can be aligned with any of the alignment apertures 122A-N of the extendable portion 106. The hitch pin 120 can then be threaded/placed through the aperture 302 and one of the alignment apertures 122A-N to secure the extendable portion 106 to the support leg 104 at the desired height.

The support leg 104 also includes an aperture 304 that extends through the support leg 104 from one side to an opposing side of the support leg 104. The aperture 304 can align with the J-Hook stops of the pivotable base 102 (e.g., refer to FIG. 1). The hitch pin 118 can then be threaded/placed through the J-Hook stops and secured in place through the aperture 304. As a result, the support leg 104 can be secured to the pivotable base 102 regardless of whether the pivotable base 102 rests on a flat, even surface and/or pivots forward or backward to rest on an uneven surface (e.g., a sloping driveway).

As shown and described herein, the side walls 114A and 114B form an opening 306 that can receive the support leg 104. The gussets 115A and 115B provide structural support to the system 100 by extending between the side walls 114A and 114B. The gussets 115A and 115B may also provide a stop as to how much the pivotable base 102 can pivot forward and backward relative to the support leg 104. This can be advantageous to prevent the support leg 104 from laying flush with the base plate 113. This can ensure that the support leg 104 maintains the moveable vessel in a level position, regardless of how much the pivotable base 102 pivots to rest on an uneven surface.

FIG. 4 is an example view of the pivotable base 102 of the moveable vessel support system 100. As shown in FIG. 4, the side walls 114A and 114B can extend in a vertical direction and perpendicular to the base plate 113. The side walls 114A and 114B define the J-Hook stops 116A and 116B, respectively. The J-Hook stops 116A and 116B are aligned with each other and configured to align with an aperture in the support leg (e.g., refer to FIGS. 1 and 3). The J-Hook stops 116A and 116B can allow for quick and easy placement and attachment of the support leg to the pivotable base 102. The J-Hook stops 116A and 116B also allow for the pivotable base 102 to pivot forward and backward while maintain the support leg in a substantially vertical direction to support the moveable vessel in a level position.

The side walls 114A and 114B can be supported by the gussets 115A (not shown) and 115B, which are positioned between the side walls 114A and 114B on opposing sides or ends of the side walls 114A and 114B. Whereas the side walls 114A and 114B can be welded or otherwise seamlessly attached to a top surface of the base plate 113, the gussets 115A and 115B can be welded or seamlessly attached to the side walls 114A and 114B but not the top surface of the base plate 113. Instead, openings 400A (not shown) and 400B can be defined between a bottom of the gussets 115A and 115B, respectively, and the base plate 113. The openings 400A and 400B can be advantageous to ensure that any water that may collect between the side walls 114A and 114B and the gussets 115A and 115B can drain out through the openings 400A and 400B. As a result, water, such as rainwater, may not collect when the system is used in an outdoor environment.

FIG. 5 depicts the moveable vessel support system 100 in operation with an example moveable vessel 500. Here, the moveable vessel 500 can be a trailer, RV, and/or camper. One or more other moveable vessels can be used, as described herein. The moveable vessel 500 includes a trailer hitch 502, a hitch coupler 504, and a jack leg 506. The hitch coupler 504 can be a variety of sizes and therefore can receive different sized hitch adapters. Therefore, as described throughout this disclosure, the user can select and install a hitch adapter of a desired size on the system 100 such that the hitch adapter can be received by the hitch coupler 504.

When the system 100 is attached to the hitch coupler 504, the system 100 is able to support the entire weight of the moveable vessel 500. As a result, the jack leg 506 does not have to bear the weight of the moveable vessel 500. The jack leg 506 may not have to rest on a pile of blocks in order to maintain the moveable vessel in a stable position on the ground. After all, as described herein, the blocks can be moveable and/or breakable. Thus, they may not provide stable support for the moveable vessel on any type of ground surface, such as a sloped driveway and/or some other uneven surface. The system 100 can extend the life of the jack leg 506 by preventing the jack leg 506 from failing under the pressure of the moveable vessel 500's weight. Since the jack leg 506 is not being used when the moveable vessel 500 is stationary and supported by the system 100, the user can pull a fuse of the jack leg 506, which can be advantageous to prevent theft of the moveable vessel 500 since the moveable vessel 500 may not be moved up and down.

As shown in FIG. 5, the pivotable base 102 is resting on a relatively flat driveway. Therefore, the support leg 104 is extending in a substantially vertical direction that is relatively perpendicular to the pivotable base 102. The extendable portion 106 has been extended to a desired height, and the hitch pin 120 is secured through the aperture of the support leg 104 and the fifth alignment aperture 122N of the extendable portion 106. The moveable vessel 500 is therefore supported in a level position on the driveway. The user can continue to operate components of the moveable vessel 500 as described herein, such as the refrigerator and the slide out.

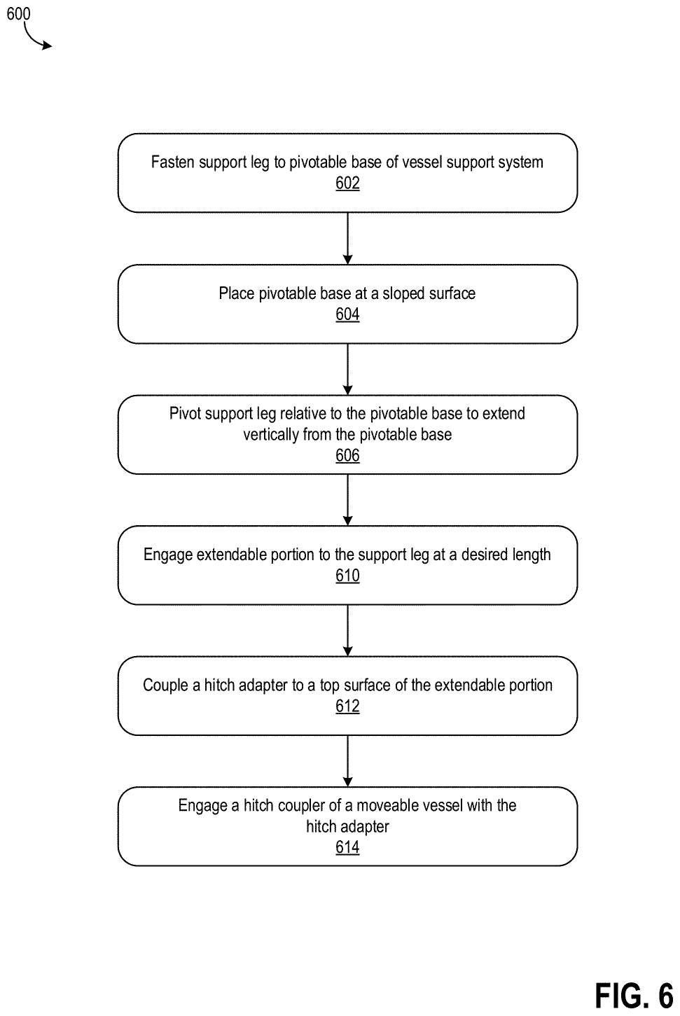

FIG. 6 is a flowchart of a process 600 for assembling the moveable vessel support system described herein. The system can be easily and quickly assembled and disassembled by the user. Assembly and disassembly may require few tools, if any, thereby making the process 600 easy, intuitive, and fast. The process 600 can also be advantageous to disassembly the system and put it in storage or bring it with the user for use in another location (e.g., use the system to temporarily store an RV on a driveway then bring the system to a campground to support the RV in the campground).

Referring to the process 600, the user can fasten the support leg to the pivotable base of the moveable vessel support system in 602. Fastening the support leg to the pivotable base can include engaging the leg to the base. As a result, the base can pivot forwards and backwards relative to a sloped surface. The leg can extend in a vertical direction to maintain the moveable vessel level relative to the sloped surface. The pivotable base can also include two J-Hook stops that align with two corresponding apertures that are defined by the support leg. The two J-Hook stops of the pivotable base and the two corresponding apertures of the support leg can receive an alignment pin to secure (e.g., fasten, engage) the support leg to the pivotable base.

Next, the user can place the pivotable base at a sloped surface (604). The pivotable base can lay flush with the sloped surface. In 606, the user can pivot the support leg relative to the pivotable base to extend vertically from the pivotable base. As a result, when the moveable vessel is coupled to the support system, the moveable vessel can be maintained level (e.g., horizontally) relative to the sloped surface and regardless of how steep an incline or decline of the sloped surface.

The user can engage an extendable portion to the support leg at a desired length (610). The extendable portion can be used to extend a total length of the support system such that moveable vessels of varying heights can be supported when attached thereto. The extendable portion can have an extendable length along a substantially vertical dimension. In some implementations, when the moveable vessel has a height that can be supported by the support leg alone, the extendable portion may not be engaged with the support leg. In some implementations, when the moveable vessel has a height that is supported by the total length of the support leg (e.g., 24 inches), the extendable portion can be telescoped entirely into the support leg. When the moveable vessel has a height that is greater than the total length of the support leg, the extendable portion can be engaged with the support leg and telescoped at least partially out of the support leg, thereby extending a length of the support system. In some implementations, when the extendable portion is extended to its greatest length and engaged with the support leg, the support system can have a total length of 42 inches. One or more other lengths are possible. For example, during manufacturing of the support system, the support leg and/or the extendable portion can be manufactured in varying sizes and lengths to accommodate different types of moveable vessels.

Engaging the extendable portion to the support leg can include securing the extendable portion at the desired length between first end and second ends of the support leg by inserting an second alignment pin through corresponding apertures of the extendable portion and the support leg.

The user can couple a hitch adapter to a top surface of the extendable portion in 612. For example, the user can insert a base of the hitch adapter through an opening at a top surface of the extendable portion. The user can then insert a nut through a second opening along a side of the extendable portion and adjacent to the top surface. Next, the user can fasten the nut around the base of the hitch adapter to releasably secure the base of the hitch adapter inside a cavity of the extendable portion. As described throughout this disclosure, the user can couple different sized hitch adapters to the support system. The different sized hitch adapters can be used to make the support system compatible with different types of moveable vessels. This is beneficial because the user can easily remove and swap out the hitch adapter with other hitch adapters depending on what type of moveable vessel the user desires to store with the support system.

The user can engage a hitch coupler of the moveable vessel with the hitch adapter in 614. Engaging the hitch coupler of the moveable vessel with the hitch adapter can simply include lowering the hitch coupler of the moveable vessel ono the hitch adapter. As described herein, the hitch adapter can be a ball shape and can have one or more surfaces that can engage with the hitch coupler. The hitch coupler can be part of the moveable vessel and can be shaped into a cavity to receive the hitch adapter. For example, if the hitch coupler is ball shaped, the hitch adapter be a cavity of corresponding size to the hitch coupler, thereby configured to receive the hitch adapter within the cavity and securely maintain the moveable vessel in a level, supported position by the support system.

One or more of the blocks 602-614 can be performed in a different order. For example, blocks 602 and 610 can be performed before performing blocks 604 and 606. Moreover, in some implementations, one or more of the blocks 602-614 may be optional. For example, the user may not perform block 610 because the moveable vessel may have a height that is not greater than a maximum length of the support leg. One or more other variations of the process 600 are possible.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A vessel support system for supporting a moveable vessel, the system comprising:
a base; and
a leg that is coupled to and extending from the base, the leg configured to pivot relative to the base and be fixedly supported at the base in at least one position;
wherein the leg is configured to engage a hitch coupler of the moveable vessel, and
wherein the leg is configured to, based on the base being positioned at a sloped surface, extend vertically to thereby support the moveable vessel at the hitch coupler of the moveable vessel.

2. The vessel support system of claim 1, wherein the leg is configured to extend from the base at different lengths to accommodate different heights of the moveable vessel.

3. The vessel support system of claim 2, wherein the different lengths include a range between 24 inches and 42 inches.

4. The vessel support system of claim 1, wherein the leg includes:
a support leg that is coupled to the base; and
an extendible portion configured to extend from the support leg at different lengths that maintains the moveable vessel in a level position relative to the sloped surface.

5. The vessel support system of claim 4, wherein the extendible portion is configured to telescope into and out of the support leg.

6. The vessel support system of claim 1, wherein the leg is configured to engage a hitch adapter, the hitch adapter being attached to the hitch coupler of the moveable vessel.

7. The vessel support system of claim 4, wherein the extendable portion comprises:
a first opening at a top surface of the extendable portion configured to receive a base of a hitch adapter, wherein the hitch adapter includes one or more surfaces that support and releasably attach to the hitch coupler of the moveable vessel.

8. The vessel support system of claim 7, wherein the extendable portion further comprises:
a second opening along a first side of the extendable portion proximate the top surface, wherein the second opening is configured to receive a nut that secures the base of the hitch adapter within a cavity of the extendable portion.

9. The vessel support system of claim 1, wherein:
the base includes two J-Hook stops on opposing sides of the base,
wherein the leg includes two corresponding apertures that are configured to align with the two J-Hook stops of the base, and
wherein the two J-Hook stops of the base and the two corresponding apertures of the leg are configured to receive at least one alignment pin that couples the leg to the base in a position that maintains the moveable vessel level relative to the sloped surface.

10. A vessel support system for storage of a moveable vessel, the vessel support system comprising:
a base that supports a moveable vessel on a surface, wherein the base is configured to pivot forward and backward relative to a support leg to maintain the moveable vessel in a level position relative to the support leg;
a support leg that includes a first end and a second end, wherein the first end is configured to attach to the base and the second end is configured to extend away from the base in a vertical direction; and
an extendable portion that telescopes into and out of the support leg, wherein the extendible portion extends a length along a substantially vertical dimension from the support leg, wherein the extendable portion comprises:
a first opening at a top surface of the extendable portion configured to receive a base of a hitch adapter, wherein the hitch adapter includes one or more surfaces that support and releasably attach to a hitch coupler of the moveable vessel; and
a second opening along a first side of the extendable portion proximate the top surface, wherein the second opening is configured to receive a nut that secures the base of the hitch adapter within a cavity of the extendable portion.

11. The vessel support system of claim 10, wherein the moveable vessel is at least one of an RV, camper, boat, and trailer.

12. The vessel support system of claim 10, wherein:
the extendable portion defines a plurality of alignment apertures configured to receive at least one alignment pin when the extendable portion is extended to a desired length,
wherein the at least one alignment pin is configured to pass through alignment apertures in the support leg and the extendable portion to maintain the extendable portion at the desired length, and
wherein the at least one alignment pin is a hitch pin.

13. The vessel support system of claim 10, wherein:
the base includes two J-Hook stops on opposing sides of the base,
the support leg includes two corresponding apertures that are configured to align with the two J-Hook stops of the base, and
the two J-Hook stops of the base and the two corresponding apertures of the support leg are configured to receive at least one alignment pin that couples the support leg to the base.

14. The vessel support system of claim 10, wherein the support leg is at least one of aluminum and steel.

15. The vessel support system of claim 10, wherein the support leg has a first length of 24 inches when the extendable portion is entirely telescoped into the support leg and wherein the support leg has a second length of 42 inches when the extendable portion is telescoped out of the support leg and extended to a full desired length.

16. The vessel support system of claim 10, wherein all a weight of the moveable vessel is supported by the vessel support system.

17. A method for supporting a moveable vessel, the method comprising:
engaging a leg to a base;
placing the base at a sloped surface;
pivoting the leg relative to the base so that the leg extends vertically from the base;
fastening the leg to the base with the leg extending vertically from the base to maintain the moveable vessel level relative to the sloped surface; and
engaging a hitch coupler of the moveable vessel to the leg.

18. The method of claim 17, further comprising:
inserting an extendable portion into the leg such that the extendable portion telescopes into and out of the leg;
extending the extendable portion out of the leg to a desired length; and
engaging the extendable portion to the leg at the desired length by inserting an alignment pin through corresponding apertures of the extendable portion and the leg.

19. The method of claim 17, wherein engaging a hitch coupler of the moveable vessel to the leg comprises:
inserting a base of a hitch adapter through an opening at a top surface of the extendable portion;
inserting a nut through a second opening along a side of the extendable portion and adjacent to the top surface;
fastening the nut around the base of the hitch adapter to releasably couple the base of the hitch adapter inside a cavity of the extendable portion; and
lowering the hitch coupler of the moveable vessel onto the hitch adapter.

20. The method of claim 17, wherein engaging a hitch coupler of the moveable vessel to the leg comprises:
inserting a base of a hitch adapter through an opening at a top surface of the extendable portion;
threading the base of the hitch adapter into a cavity of the extendable portion to releasably couple the hitch adapter to the extendable portion; and
lowering the hitch coupler of the moveable vessel onto the hitch adapter.
